(19) United States
(12) Patent Application Publication
(10) Pub. No.: US 2023/0365740 A1
(43) Pub. Date: Nov. 16, 2023

(54) POLYURETHANES AND METHODS TO PREPARE POLYURETHANES

(71) Applicants: The Regents of the University of California, Oakland, CA (US); University of Tennessee Research Foundation, Knoxville, TN (US)

(72) Inventors: Charles M. Cai, Riverside, CA (US); Yun-Yan Wang, Rolla, MO (US); Arthur Ragauskas, Kingston, TN (US)

(21) Appl. No.: 18/139,768

(22) Filed: Apr. 26, 2023

Related U.S. Application Data
(60) Provisional application No. 63/335,166, filed on Apr. 26, 2022.

(51) Int. Cl. C08G 18/64; C08G 18/76; C08G 18/67; C08G 18/32; C08G 18/48; C08G 18/65; C08G 18/40; C08G 18/08; C08G 18/24

(52) U.S. Cl. CPC C08G 18/6492; C08G 18/7671; C08G 18/675; C08G 18/3206; C08G 18/48; C08G 18/6511; C08G 18/4081; C08G 18/0842; C08G 18/246

(57) ABSTRACT

The invention provides a method of production of biogenic lignin-based polyurethane having soft-segments from the co-polymerization of an organosolv lignin or other low molecular weight lignin and a monomeric polyol. The invention also provides polyurethanes having unique and beneficial properties.

### CROSS REFERENCE TO RELATED APPLICATION

This application claims priority to U.S. Provisional Application No. 63/335,166, filed on Apr. 26, 2022. The entire content of this application is hereby incorporated by reference herein.

### GOVERNMENT FUNDING

This invention was made with government support under 2016-10008-25321 awarded by National Institute of Food and Agriculture, USDA. The government has certain rights in the invention.

### BACKGROUND

Polyurethanes (PU) were discovered in 1937 by Otta Bayer and his co-workers at I.G. Farbenindustrie in Leverkusen, Germany. Since then numerous commodity PU materials including elastomers, flexible/rigid foams, films, coatings, fibers, and thermoplastics, were developed by controlling the PU chemical structures displaying chain flexibility, crystallinity, interchain interaction, and crosslinking density (Hepburn, C., Polyurethane Elastomers. 2 ed.; Elsevier Science Publishers LTD: New York, NY, USA, 1992). In 2017, approximately 5.8 billion pounds of PU materials were consumed in various end-use markets such as building and construction, furniture, and bedding with an economic output reaching $296.8 billion in the US (The Economic Benefits of the U.S. Polyurethanes Industry 2017; American Chemistry Council: Arlington VA, USA, October 2018).

One growing interest in green chemistry is focused on the utilization of low-cost technical lignins in commodity polymeric materials including PU (Wang, Y.-Y., et al., Polymers 2020, 12, 2277). Lignin has been viewed as the most abundant biogenic aromatic polymer possessing various functional groups such as hydroxyl, methoxy, carboxyl, and carbonyl groups. A representative structural model of native lignin is constituted of three subunits including p-hydroxyphenyl (H), guaiacyl (G), and syringyl (S), and these phenylpropane units are mainly connected via β-O-4′, β-5′, β-β′, 5-5′, and 4-O-5′ interunit linkages (Ralph, J., et al., Phytochem. Rev. 2004, 3, (1), 29-60; and Giummarella, N., et al., Green Chem. 2019, 21, (7), 1573-1595).

Currently, ˜1.1 million tons of commercial lignin is produced annually in four major industrial processes: sulfite, Kraft, soda and organosolv (Upton, B. M., et al., Chem. Rev. 2016, 116, (4), 2275-2306). These technical lignins could be supplied as sustainable replacements for petrochemical polyols in the production of commodity PU materials (Upton, B. M., et al., Chem. Rev. 2016, 116, (4), 2275-2306; Glasser, W. G., About Making Lignin Great Again—Some Lessons From the Past. Front. Chem. 2019, 7, 565; Wang, Y.-Y., et al., Tappi J. 2017, 16, (4), 203-207; and Alinejad, M., et al., Polymers 2019, 11, (7), 1202).

The chemicals used in isolating technical lignins can leave undesirable impurities in the final lignin-based polymers, meanwhile, the heterogeneity of native lignin structure could be detrimentally increased during the pulping or pretreatment process. These factors can potentially limit the amount of lignin that could be incorporated into a polymeric system due to deteriorating material properties as lignin incorporation increases. Therefore, refining technical lignins has been widely investigated to remove impurities and isolate specific lignin cuts with distinct molecular weights, to narrow molecular weight dispersity (D), and more importantly, to enhance solubility in common organic solvents (Duval, A., et al., Holzforschung 2016, 70, (1), 11-20; Sadeghifar, H., et al., ACS Sustainable Chem. Eng. 2017, 5, (1), 580-587; Wang, Y.-Y., et al., ACS Sustainable Chem. Eng. 2018, 6, (5), 6064-6072; Meng, X., et al., Bioresour. Technol. 2019, 272, 202-208; and Jiang, X., et al., ACS Sustainable Chem. Eng. 2017, 5, (1), 835-842). The implementation of lignin refining would support the ideal fabrication of polymer networks with tailored lignin structures. Gioia et al. demonstrated that the material properties of lignin-based epoxies can be improved vastly by increasing the molecular weight of lignin (Gioia, C., et al., J. Am. Chem. Soc. 2018, 140, (11), 4054-4061). Similar trends were observed in our previous study of lignin-based polyurethanes (Wang, Y.-Y., et al., ACS Appl. Polym. Mater. 2019, 1, (7), 1672-1679). Yet, undesirable dispersion and compatibility refrained the utilization of high-molecular-weight lignin cuts in the material matrix.

Recently, lignin-based epoxies showing tensile strength up to 66 MPa were synthesized from low-molecular-weight (M̅_{w} 1000˜1500 g/mol) cuts obtained by sequential extracting softwood and hardwood Kraft lignins with organic solvents (Gioia, C., et al., Biomacromolecules 2020, 21, (5), 1920-1928). In the synthesis of high-performance PU elastomers, lignin oligomers (M̅_{w} 1000˜1800 g/mol) with enriched phenolic hydroxyl groups were prepared by depolymerizing technical lignins in hot aqueous alkaline solution (Li, H., et al., ACS Sustainable Chem. Eng. 2017, 5, (9), 7942-7949; and Liu, W., et al., Macromol. 2019, 52, (17), 6474-6484). On the other side, oligomeric technical lignin with reduced polar functional groups can be produced directly by using new processing chemistry and technology. The lignin oligomers (M̅_{w} 1600˜2000 g/mol) obtained via aldehyde-assisted fractionation process showed better compatibility with the PU networks than the methyl ethyl ketone extracted Kraft lignin (M̅_{w} 1600˜2000 g/mol) (Vendamme, R., et al., Biomacromolecules 2020, 21, (10), 4135-4148).

Novel organosols or co-solvent pretreatments developed for lignocellulosic biorefining enables lignin extraction using biomass-derived organic solvents under acidic conditions at elevated temperatures (Meng, X., et al., Green Chem. 2020, 22, (9), 2862-2872; Shuai, L., et al., Green Chem. 2016, 18, (4), 937-943; Cai, C. M., et al., Green Chem. 2013, 15, (11), 3140-3145; and Li, S.-X. , et al., Bioresour. Technol. 2017, 243, 1105-1111). The Co-solvent Enhanced Lignocellulosic Fractionation (CELF) process employing miscible solutions of tetrahydrofuran (THF) and water with dilute acid can produce technical lignins featuring high lignin yield from biomass and purity. In the previous study, we have demonstrated that CELF lignin's molecular weight, backbone structure, functional groups, and solubility in common organic solvents can be tuned by changing the pretreatment reaction conditions (Wang, Y.-Y. , et al., Front. Energy Res. 2020, 8, (149)).

### SUMMARY

Certain embodiments of the invention provide a method for the production of biogenic polyurethane coating and adhesives as described herein.

In one embodiment, the invention provides a method comprising, co-polymerizing:
an organosolv lignin;
a monomeric polyol; and
an isocyanate;
   to provide a polyurethane.

In one embodiment, the invention provides a polyurethane prepared according to a method of the invention.

In one embodiment, the invention provides a polyurethane comprising lignin that is co-polymerized with a monomeric polyol and an isocyanate

### BRIEF DESCRIPTION

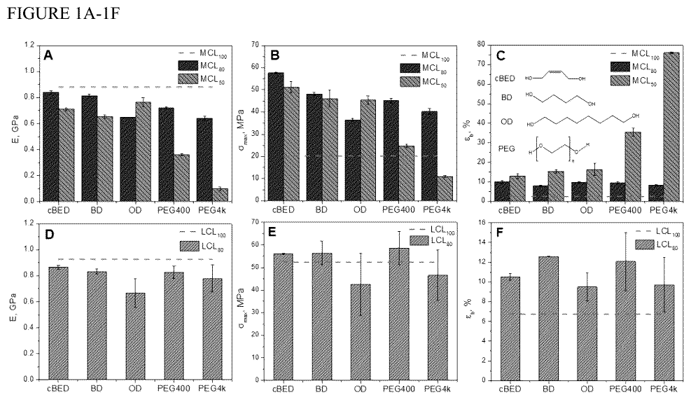

FIGS. 1A-1F show tensile properties including Young's modulus (E), ultimate tensile stress (σₘₐₓ) and elongation at break (ε_{b}) of the CELF lignin-based polyurethanes synthesized from the medium-molecular weight CL160 cut (MCL-PUs) (FIGS. 1A, 1B, 1C) and the polyurethanes produced from low-molecular weight CL160 cut (LCL -PUs) (FIGS. 1D, 1E, 1F) in the presence or absence of secondary hydroxyl providers.

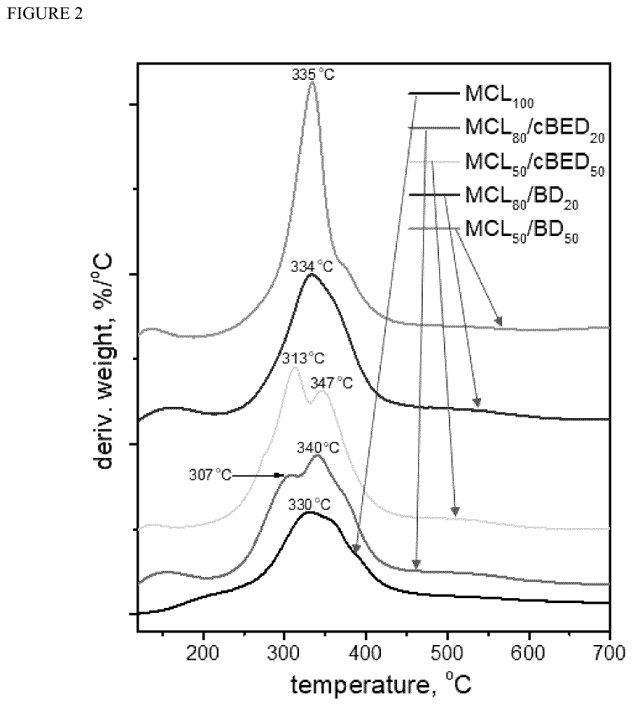

FIG. 2 shows the difference in the thermal degradation behavior of MCL-PUs formulating with cBED and BD in a N₂ atomersphere.

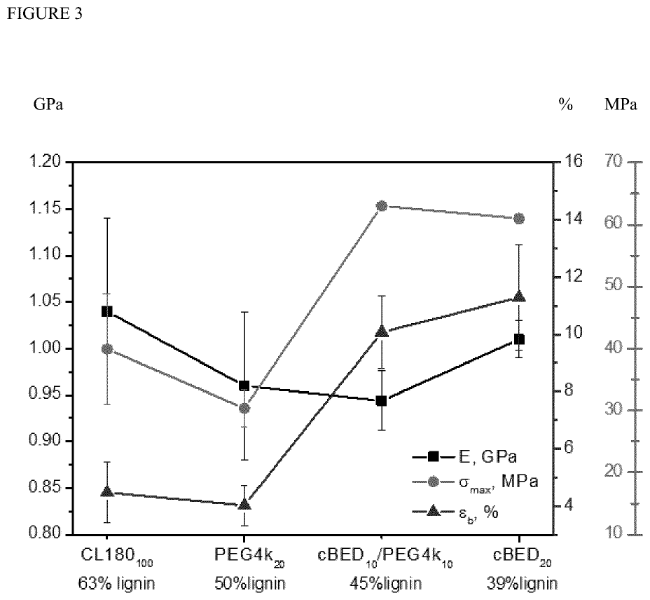

FIG. 3 shows tuning the tensile properties of CELF lignin-based polyurethanes synthesized from CL180 (CL180-PUs) by secondary hydroxyl provider: PEG4k and cBED.

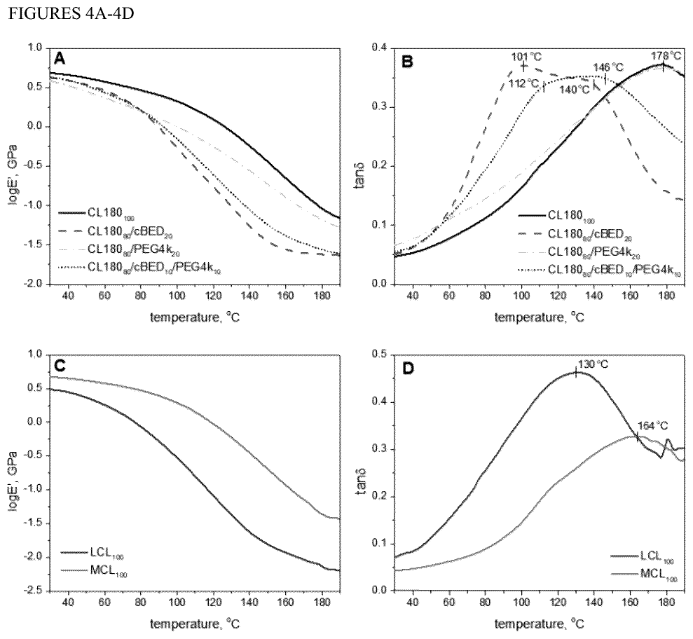

FIGS. 4A-4D shows the impacts of cBED and PEG4k on the storage molulus (E′) (FIG. 4A) and tand (FIG. 4B) of CL180-PUs. The comparision between CELF lignin-based polyurethanes produced from LCL and MCL as the only polyol (LCL₁₀₀ and MCL₁₀₀.): the storage molulus (E′) (FIG. 4C) and tanδ (FIG. 4D).

### DETAILED DESCRIPTION

The structural complexity and robust intermolecular interactions have challenged the incorporation of technical lignin into value-added polymeric materials for decades. To study the correlation between lignin molecular structure and material properties of lignin-based polyurethanes, we applied Co-solvent Enhanced Lignocellulosic Fractionation (CELF) pretreatment followed by sequential precipitation to produce three distinct lignin preparations with narrowly distributed (<2) and comparatively low molecular weight (<1500 g/mol) from poplar biomass. Structural characterization indicated that these lignin preparations differed in average molecular chain length and stiffness as well as hydroxyl group distribution. Secondary hydroxyl group providers such as aliphatic diols and polyethers were incorporated as building-blocks into the lignin-based polyurethanes to provide additional hydrogen capacity to improve the dispersion of lignin in the PU network. The selected aliphatic diols and polyethers interacted with lignin molecules at different levels of strength depending on their molecular structure, and their impacts were ultimately reflected in the mechanical and thermal properties of the resulting lignin-based polyurethanes. The copolymerization of technical lignin with tailored structure and secondary hydroxyl providers could provide new strategies in formulating lignin-based/containing polyurethanes for various functional applications.

The mechanical performance of CELF-based PUs was determined by the solubility of CELF lignin streams in a casting solvent such as THF. The CELF lignin stream extracted at 160° C. (CL160) was refined by a novel sequential precipitation step employing THF-methanol co-solvent to solubilize the lignin while adding hexane as an antisolvent to promote precipitation. CELF lignin-based PUs (CL-PU) were fabricated from two lignin fractional cuts produced from 160° C. and one CELF lignin stream produced at 180° C. pretreatment temperature. These CELF lignin preparations were readily soluble in THF at room temperature, and differences in their chemical composition, backbone structure, and functional group distribution could potentially affect the mechanical performance of final CL-PUs. Monomeric diols and polyethers were employed as the secondary hydroxyl provider in the synthesis of CL-PUs. Besides serving as a building block and providing additional hydrogen bonding capacity that improves the dispersion of CELF lignin in the PU matrix, tailoring the chemical structure of secondary hydroxyl provider and their molecular interactions with lignin could be applied as a new strategic tool in the development of highly functional lignin-based PUs for commercial applications.

### Embodiments

Certain embodiments of the invention provide a method for production of biogenic polyurethane coating and adhesives, comprising: mixing biomass lignin, monomeric polyols, and volatile organic solvent at a temperature ranging from about 20 to about 65° C. to synthesize polyurethanes containing from about 20 to about 60% lignin and from about 10 to about 80% monomeric polyols.

In certain embodiments, the monomeric polyols are selected from the group consisting of 1,3-propanediol, propylene glycol, 1,4-butanediol, 1,3-butanediol, cis-butene-1,4-diol, trans-butene-1,4-diol, 3-hexene-1,6-diol, and glycerol.

In certain embodiments, the biomass lignin is defined as lignin extracted from lignocellulosic biomass using organosolv pretreatment or pulping, ionic liquid pretreatment or pulping, deep eutectic salts pretreatment or pulping, reductive catalytic fractionation extraction of lignin

In certain embodiments, the lignocellulosic biomass is defined as a material containing one or more of corn stover, wheat straw, palm fronds, municipal green waste, forestry residues, agricultural residues, hardwoods, softwoods, miscanthus, sugarcane bagasse, oat hulls, switchgrass, bamboo stalk, hemp stalk, hemp hurd, or hemp bast fiber.

In certain embodiments, the organosolv pretreatment or pulping is defined as a process that solubilizes and removes lignin from lignocellulosic biomass by treating it under conditions and environment comprising an aqueous co-solvent mixture comprising of methanol, ethanol, tetrahydrofuran, or gamma-valerolactone.

In certain embodiments, the chemically unmodified technical lignins can be directly converted into polyurethane as the primary polyols in the presence of aliphatic diols as the secondary polyols. In certain embodiments the synthesis of lignin-PU starts with fully dissolving a technical lignin in the presence of a diol or a mixture of diols in volatile organic solvents. In certain embodiments, the polyol solution was mixed with isocyanate compounds and catalyst to form PU by solvent casting. In certain embodiments, the dried PU materials were cured at 150° C.

Due to the inherent strong intermolecular forces between lignin macromolecules, miscibility and dispersion of technical lignin is an obstacle for producing high performance lignin-PU. As described herein, diols were introduced to realize faster and complete dissolution of technical lignin in volatile organic solvents, which improve lignin miscibility with other components and its dispersion in the PU materials. The diols were incorporated into the PU materials as chain extenders or crosslinkers to enhance the material performance.

The term “organosolv lignin” includes lignins that have been isolated by co-solvent extraction from biomass. In one embodiment, the organosolv lignin has an average molecular weight of less than about 1500 g/mole. In one embodiment, the organosolv lignin has an average molecular weight of less than about 1200 g/mole. In one embodiment, the organosolv lignin has an average molecular weight of less than about 1000 g/mole. In one embodiment, the organosolv lignin has an average molecular weight of less than about 800 g/mole. In one embodiment, the organosolv lignin has an average molecular weight of greater than about 500 g/mole. In one embodiment, the organosolv lignin has an average molecular weight of greater than about 800 g/mole. In one embodiment, the organosolv lignin can be prepared by co-solvent extraction from biomass with a solvent comprising water and acetone, ethanol, methanol, tetrahydrofuran, or gamma-valerolactone. In one embodiment, the organosolv lignin has a phenolic OH content to 50-70%. In one embodiment, the organosolv lignin has an aliphatic OH content to below 55%.

The term “monomeric polyol” includes any monomeric polyol that can be co-polymerized with lignin to provide a polyurethane according to a method of the invention. In one embodiment, the monomeric polyol is selected from the group consisting of 1,3-propanediol, propylene glycol, 1,4-butanediol, 1,3-butanediol, cis-butene-1,4-diol, trans-butene-1,4-diol, 3-hexene-1,6-diol, and glycerol. In one embodiment, the monomeric polyol comprises cis-butene-1,4-diol.

The term “isocyanate” includes any isocyanate that can be incorporated into a polyurethanes according to a method of the invention. In one embodiment, the isocyanate is a diisocyanate or a polyisocyanate. In one embodiment, the isocyanate comprises poly[(phenyl isocyanate)-co-formaldehyde or Methylene diphenyl diisocyanate. In one embodiment, the poly[(phenyl isocyanate)-co-formaldehyde has an NCO/OH ratio of about 1:1.

In one embodiment, the co-polymerizing is carried out in a solvent that comprises a volatile-organic-solvent. In one embodiment, the volatile-organic-solvent is selected from the group consisting of tetrahydrofuran, methanol, n-hexane, and toluene. In one embodiment, the solvent comprises tetrahydrofuran.

In one embodiment, the co-polymerizing is carried out in the presence of a catalyst. In one embodiment, the co-polymerizing is carried out in the presence of dibutyltin dilaurate catalyst. In one embodiment, the dibutyltin dilaurate catalyst is present at 1.5% by weight of the total mixture.

In one embodiment, the co-polymerizing is carried out at a temperature below about 65° C. In one embodiment, the co-polymerizing is carried out at a temperature ranging from 20-65° C.

In one embodiment, the polyurethane of the invention comprises at least about 20% lignin. In one embodiment, the polyurethane comprises at least about 30% lignin. In one embodiment, the polyurethane comprises at least about 40% lignin. In one embodiment, the polyurethane comprises at least about 50% lignin. In one embodiment, the polyurethane comprises less than about 60% lignin. In one embodiment, the polyurethane comprises less than about 50% lignin. In one embodiment, the polyurethane comprises 20-65% lignin. In one embodiment, the polyurethane comprises 20-60% lignin.

In one embodiment, the polyurethane comprises at least about 2% monomeric polyol. In one embodiment, the polyurethane comprises at least about 5% monomeric polyol. In one embodiment, the polyurethane comprises at least about 10% monomeric polyol. In one embodiment, the polyurethane comprises at least about 20% monomeric polyol. In one embodiment, the polyurethane comprises at least about 30% monomeric polyol. In one embodiment, the polyurethane comprises at least about 40% monomeric polyol. In one embodiment, the polyurethane comprises at least about 50% monomeric polyol. In one embodiment, the polyurethane comprises at least about 60% monomeric polyol. In one embodiment, the polyurethane comprises at least about 70% monomeric polyol. In one embodiment, the polyurethane comprises 10-80% monomeric polyol.

Co-polymerizing organosolv lignin with a monomeric polyol provides a polyurethane that is cross-linked with the monomeric polyol, yielding soft-segments within the polyurethane and producing polyurethanes with unique and beneficial properties. In one embodiment, the polyurethane has an ultimate tensile stress (σₘₐₓ) of at least about 50 MPa. In one embodiment, the polyurethane has an elongation at break (ε_{b}) of at least about 4%. In one embodiment, the polyurethane has an elongation at break (ε_{b}) of at least about 5%. In one embodiment, the polyurethane has an elongation at break (ε_{b}) of at least about 6%. In one embodiment, the polyurethane has an elongation at break (ε_{b}) of at least about 7%. In one embodiment, the polyurethane has an elongation at break (ε_{b}) of at least about 8%. In one embodiment, the polyurethane has a glass transition temperatures (Tg) between about 100° C. and about 180° C. In one embodiment, the polyurethane has a glass transition temperatures (Tg) between about 100° C. and about 160° C. In one embodiment, the polyurethane has a glass transition temperatures 30 (Tg) between about 100° C. and about 130° C.

Certain embodiments of the invention will be illustrated in the following non-limiting Examples.

### EXAMPLES

### Example 1

### Materials and Chemicals

The poplar biomass was sourced from Oak Ridge National Laboratories (ORNL) known as BESC (BioEnergy Science Center) Standard Poplar. This poplar has been used in numerous previous studies supporting CELF pretreatment research (Thomas, V. A. , et al., Biotechnol. Biofuels 2017, 10, (1), 252; Mostofian, B., et al., J. Am. Chem. Soc. 2016, 138, (34), 10869-10878; and Patri, A. S., et al., Biotechnol. Biofuels 2019, 12, (1), 177). The poplar wood chips were first knife-milled by a Thomas-Wiley laboratory mill (model 4) through a 2 mm particle screen before pretreatment. Tetrahydrofuran, methanol, hexane, cis-2-butene-1,4-diol (cBED), 1,4-butanediol (BD), 1,8-octanediol (OD), polyethylene glycol (MW˜400, PEG400), polyethylene glycol (MW˜4000, PEG4k), poly[(phenyl isocyanate)-co-formaldehyde] (average Mₙ ˜340, ˜2.7 isocyanate groups/molecule, PMDI), dibutyltin dilaurate (DTDL) were purchased from Sigma-Aldrich. All chemicals were used as received.

### Preparation and Fractionation of CELF Lignin

The preparation of CELF lignin was described in a previous literature (Wang, Y.-Y. , et al., Front. Energy Res. 2020, 8, (149)). n brief, the milled poplar biomass (7.5 wt % solids loading) was treated in THF/water (1:1 w/w) solution containing 0.5 wt % sulfuric acid in a 1 L Hastelloy Parr autoclave reactor (Parr Instruments Co., Moline, IL). The CELF pretreatment was performed at the target temperature for 15 minutes, deemed optimal for lignin extraction without extensive loss of sugars (Thomas, V. A. , et al., Biotechnol. Biofuels 2017, 10, (1), 252). After the reaction, the liquid fraction was collected, and then neutralized by ammonium hydroxide. The remaining THF was removed by open-air boiling at 70° C. in a vapor hood, and the precipitated CELF lignin was collected by filtration, washed extensively with DI water, and air dried at 65° C. in an oven. The resulting CELF lignin powder samples were designated as CL160 and CL180 based upon their corresponding pretreatment temperature (160° C. and 180° C.).

CL160 was fractionated by sequential precipitation from THF-methanol (1:1, v/v) cosolvent using hexane as an antisolvent.¹² In this work, 50 g of CL160 was dissolved in 500 mL THF-methanol cosolvent a room temperature. The high-molecular-weight CL160 cut precipitated out from the cosolvent after adding 150 mL hexane. The resulting supernatant was mixed with additional 350 mL hexane to generate the medium-molecular-weight CL160 cut (MCL) that accounts for 23.1% of the parent CL160. The low-molecular weight CL160 cut (LCL, 22.2% of the parent CL160) in the liquid phase was collected by removing the solvents by rotary evaporation. The dry solid CL160 cuts were incubated in the oven at 40° C. for 48 hours before characterization and PU synthesis.

### Synthesis of CL-PUs

The polycondensation reaction between polyols and PMDI was catalyzed by 1.5% DTDL in THF.²⁵ The CELF lignin samples (MCL, LCL, and CL180) and the selected hydroxyl providers such as cBED, BD, OD, PEG400, and PEG4k were employed for fabricating CL-PUs according to the formulations listed in Table 1. The CL-PU samples for tensile testing and dynamic mechanical analysis (DMA) were produced via solution casting from THF in a manner that has been reported previously (Wang, Y.-Y., et al., ACS Appl. Polym. Mater. 2019, 1, (7), 1672-1679).

TABLE 1
The composition of CL-PUs formulated from the medium-
molecular weight CL160 cut (MCL), low-molecular weight
CL160 cut (LCL) and CL180. (NCO/OH = 1:1).

| CL-PUª | lignin % | diol/polyether % | PMDI % |
|---|---|---|---|
| MCL₁₀₀ | 62.4 | | 37.6 |
| MCL₈₀/cBED₂₀ | 38.8 | 9.7 | 51.5 |
| MCL₅₀/cBED₅₀ | 18.3 | 18.3 | 63.4 |
| MCL₈₀/BD₂₀ | 39.0 | 9.8 | 51.2 |
| MCL₅₀/BD₅₀ | 18.5 | 18.5 | 63.0 |
| MCL₈₀/OD₂₀ | 43.7 | 10.9 | 45.4 |
| MCL₅₀/OD₅₀ | 23.1 | 23.1 | 53.8 |
| MCL₈₀/PEG400₂₀ | 49.5 | 12.4 | 38.1 |
| MCL₅₀/PEG400₅₀ | 30.8 | 30.8 | 38.4 |
| MCL₈₀/PEG4k₂₀ | 53.4 | 13.4 | 33.2 |
| MCL₅₀/PEG4k₅₀ | 37.6 | 37.6 | 24.8 |
| LCL₁₀₀ | 59.7 | | 40.3 |
| LCL₈₀/cBED₂₀ | 37.8 | 9.5 | 52.7 |
| LCL₈₀/BD₂₀ | 38.1 | 9.5 | 52.4 |
| LCL₈₀/OD₂₀ | 42.4 | 10.6 | 47.0 |
| LCL₈₀/PEG400₂₀ | 48.0 | 12.0 | 40.0 |
| LCL₈₀/PEG4k₂₀ | 51.6 | 12.9 | 35.5 |
| CL180₁₀₀ | 62.9 | | 37.1 |
| CL180₈₀/cBED₂₀ | 39.1 | 9.8 | 51.1 |
| CL180₈₀/PEG4k₂₀ | 54.0 | 13.5 | 32.5 |
| CL180₈₀/PEG4k_{10/}cBED₁₀ | 45.4 | 5.7/5.7 | 43.3 |

^{a}The subscript number expressed the percentage of total polyol and diol applied in the corresponding CL-PU.

### Characterization of CELF Lignin and CL-PUs

The molecular weights of MCL, LCL, and CL180 employed in the CL-PUs preparation were determined by GPC analysis. In this work, ˜1 mg of lignin was dissolved in THF without acetylation and incubated overnight before subjecting to an Agilent GPC SECurity 1200 system equipped with several Waters Styragel columns (Water Corporation, Milford, MA) at a flow rate of 0.3 mL/min at 35° C. The 2D HSQC and ³¹P NMR spectra were acquired on a Bruker Avance III H 500-MHz spectrometer (Wang, Y.-Y. , et al., Front. Energy Res. 2020, 8, (149)). The ³¹P NMR analysis of the hydroxyl groups of CELF lignin were performed based on a protocol published previously (Meng, X., et al., Nat. Protoc. 2019, 14, (9), 2627-2647).

The experimental procedures and conditions of tensile testing and DMA of CL-PUs were described in detail in the previous publications (Wang, Y.-Y., et al., ACS Appl. Polym. Mater. 2019, 1, (7), 1672-1679). The error analysis for tensile testing was obtained based on the standard deviation of triplicates. The CL-PU samples were ball-milled to fine powder before subjecting to thermal gravimetric analysis (TGA) that was performed on a TA Q50 thermogravimetric analyzer (TA Instruments) at a heating rate of 20° C./min from 105 to 900° C. in an N₂. The samples were preheated to 105° C. and incubated at this temperature for 10 minutes to remove traces of moisture and solvents.

### Results and Discussion

### Structural Characterization of CELF Lignin Samples

The range of reaction temperatures selected for CELF pretreatment of poplar in this study have been reported to have significant impacts on the molecular structure of the co-product lignin (Wang, Y.-Y. , et al., Front. Energy Res. 2020, 8, (149); and Meng, X., et al., ACS Sustainable Chem. Eng. 2018, 6, (7), 8711-8718). The solvation behavior in THF of CELF lignin depends on the molecular weight and distribution of hydroxyl groups which can be correlated to the pretreatment temperature (Wang, Y.-Y. , et al., Front. Energy Res. 2020, 8, (149)). CL160 was partially soluble in THF and was fractionated via sequential precipitation to produce MCL (medium MW) and LCL (low MW), and CL180 (unrefined) which were readily soluble in THF at the experimental concentration can be subjected to the PU synthesis without any modification. In general, MCL, LCL, and CL180 possess narrow molecular weight distribution and Mw below 1500 g/mol (Table 2).

TABLE 2
Structural characterization of the medium-molecular weight CL160 cut
(MCL), low-molecular weight CL160 cut (LCL) and CL180: weight-
average molecular weight (M̅_{w}) and dispersity ( [symbol] ), hydroxyl (OH)
contents determined by GPC and ³¹P NMR analyses.

| | MCL | LCL | CL180 |
|---|---|---|---|
| M̅_{w}, g/mol | 1391 | 626 | 1132 |
| D = M̅_{w}/M̅ₙ | 1.42 | 1.29 | 1.55 |
| total OH, mmol/g | 4.78 | 5.43 | 4.68 |
| aliphatic OH, %ª | 46.9 | 37.9 | 28.9 |
| phenolic OH, %ª | 51.7 | 55.8 | 66.2 |
| COOH, %ª | 1.4 | 6.3 | 4.9 |

^{a}Content expressed as the percentage of the total —OH.

However, their physical forms, as well as molecular structure and distribution of hydroxyl groups, are quite different. The HSQC spectrum of MCL shows the typical cross-peaks of substructures (β-O-4′ ether, β-β′ resinol and β-5′ phenylcoumaran) and subunits (p-hydroxybenzoate, guaiacyl, syringyl, and their condensed and oxidized derivatives) which were observed for CELF lignin extracted from poplar biomass. MCL represents a relatively flexible molecular structure with the highest frequencies in both β-O-4′ interunit linkage and aliphatic —OH groups among the three CELF lignin samples. LCL is composed of oligomers of 3˜4 phenylpropane C₉ units with high S/G=3.9 and approximately equal amounts of β-O-4′ ether and β-β′ resinol substructures. Besides the lignin cross-peaks, the HSQC spectrum of LCL contains a substantial amount of non-lignin structures in the aliphatic region. These non-lignin components including traces of 5-hydroxymethylfurfural were concentrated down in LCL via sequential precipitation, and they might contribute to the flow behavior of LCL at elevated temperatures (>40° C.). Unrefined CL180 is a darker brown powder and forms a dark liquid solution when dissolved in THF. It was confirmed when CELF pretreatment temperature increased to 180° C., lignin underwent complex acid-catalyzed depolymerization by cleavage of aryl-ether linkages and repolymerization, and consequently, its molecular structure became more rigid and highly condensed (Wang, Y.-Y. , et al., Front. Energy Res. 2020, 8, (149)).

### Tuning Mechanical and Thermal Properties of CL-PUs by Tailed Lignin Structure and Secondary Hydroxyl Provider

One challenge that impedes the application of technical lignins in commercial polymer products is their poor solubility in organic solvents. In this work, MCL, LCL, and CL180 can all fully dissolve in THF at high concentration, and no precipitation was observed during PU formation when up to 63% of the CELF lignins were incorporated into the CL-PU (Table 1). In MCL₁₀₀ and LCL₁₀₀, lignin served as the only —OH provider in the resulting CL-PUs. Although their Young's moduli (E) were close and around 0.9 GPa (FIG. 1A), LCL₁₀₀ tended to be tougher and more ductile with ultimate stress (σₘₐₓ) around 52 MPa and elongation at break (ε_{b}) of 6.7% than MCL₁₀₀ (σₘₐₓ ˜20 MPa and ε_{b}<3%) giving that M̅_{w} of LCL is as low as ˜600 g/mol. A similar trend has been documented in the study of polyurethane elastomers made from partially depolymerized lignin (Mₙ=600 g/mol) and unmodified lignin (Mₙ=3600 g/mol) due to the high miscibility and high reactivity of the former one with poly(propylene glycol)tolylene 2,4-diisocyanate terminated (PPGTDI).¹⁸ In MCL₈₀ and LCL₈₀, by replacing 20% lignin with the secondary hydroxyl providers such as cBED, BD, OD, and PEG, the tensile properties of MCL-PUs were enhanced remarkably: σₘₐₓ by 200˜300% and ε_{b} by 300˜400% (FIG. 1B&C). The aliphatic diols including cBED, BD, and OD, improved the dispersion of MCL in the PU matrix. As they were incorporated into the PUs in relatively small amounts (10˜13%, Table 1), E and σₘₐₓ of MCL₈₀-PUs were decreasing as the diol chain length and flexibility increased from cBED to OD. Similar trends were observed for MCL₈₀/PEG400₂₀ and MCL₈₀/PEG4k₂₀. For all five MCL₈₀-PUs, ε_{b} was minimally affected by the secondary hydroxyl providers. However, when the ratio between MCL and secondary hydroxyl provider was adjusted to 1:1, the molecular structure of the latter played a more significant role on the ductility of MCL₅₀-PUs (FIG. 1C). In FIG. 1D˜F, the influence of aliphatic diols and PEGs on the mechanical properties of LCL₈₀-PUs was found to be quite insignificant, comparing with MCL₈₀-PUs. In the thermal degradation study of MCL-PUs (FIG. 2), two peaks were clearly observed for MCL₈₀/cBED₂₀ at 307° C. and 340° C., and the intensity of the first peak grew up as the content of cBED was increased from 20% to 50%, therefore the peak at 307° C. arose from the thermal decomposition of the cBED components. Meanwhile, the thermal degradation patterns of MCL-PUs containing 20% and 50% BD resembled the one of MCL₁₀₀ showing a major peak centered around 335° C.

CL180₁₀₀ produced from CL180 as the only hydroxyl provider demonstrated promising mechanical properties considering the molecular weight and total OH content of CL180 were close to MCL (FIG. 3). Unlike the situation observed for MCL₈₀-PUs, the presence of 20% PEG4k weakened σₘₐₓ by ˜25% without improvement on the ductility of CL180₈₀/PEG4k₂₀ comparing with CL180₁₀₀. PEG has conventionally been used by others as the soft segments in various lignin-based/containing polyurethanes products.^{31, 32} CL180 with abundant phenolic —OH accounting for 66% of the total —OH was expected to have excellent miscibility with PEG4k granted by the strong hydrogen bonds formed between PEG ether oxygen and lignin phenolic —OH protons (Kadla, J. F.; Kubo, S., Macromol. 2003, 36, (20), 7803-7811; and Kubo, S.; Kadla, J. F., J. Appl. Polym. Sci. 2005, 98, (3), 1437-1444). In fact, due to the strong intermolecular interaction between CL180 and PEG4k, the glass transition temperature (T_{g}) for CL180₈₀/PEG4k₂₀ remained the same as CL180₁₀₀ at 178° C. Therefore, PEG at a low incorporation level (13.5%, Table 1), was ineffective in softening the network of CL180₈₀/PEG4k₂₀, which was also revealed by its changes of storage modulus (E′) as a function of increasing temperature (FIG. 4A). On the other hand, tanδ (tanδ=loss modulus/storage modulus) of CL180₈₀/cBED₂₀ (FIG. 4B) exhibited two glass transition temperatures (T_{g}) at 101° C. and 140° C., indicating that a phase separation arose from the weaker interaction between CL180 and unsaturated aliphatic diol cBED. The biphasic transitions of rigid or rubbery materials produced by copolymerizing technical lignins and polybutadiene have been widely documented by DMA (Saito, T., et al., RSC Adv. 2013, 3, (44), 21832-21840; Saito, T., et al., Green Chem. 2012, 14, (12), 3295-3303; and Lee, Y., et al., J. Wood Chem. Technol. 2017, 37, (5), 334-342). The combination of PEG and cBED was able to effectively toughen the CL-PU containing 10% of each secondary hydroxyl provider (CL180₈₀/cBED₁₀/PEG4k₁₀, FIG. 3), and tanδ twin peaks were shifted to higher temperatures (112° C. & 146° C., FIG. 4B). In FIG. 4C, E′ of LCL₁₀₀ responded to temperature increase more rapidly than MCL₁₀₀. CL180, MCL, and LCL represented three distinct lignin preparations as discussed in the foregoing section. The variation of the glass transition temperatures of CL180₁₀₀ (178° C.), MCL₁₀₀ (164° C.), and LCL₁₀₀ (130° C.) (FIG. 4 B & D) demonstrated a clear correlation between the thermal-mechanical behavior of CL-PUs to lignin molecular weight and structure.

### SUMMARY

CL180 extracted at 180° C. with aqueous THF and two CL160 cuts, MCL and LCL, produced by sequential precipitation from THF-methanol-hexane co-solvent system were converted into CL-PUs with aliphatic diols and polyethers as the secondary hydroxyl provider. These low-molecular-weight CELF lignin samples exhibited distinct molecular structures including backbone composition and hydroxyl group distribution. MCL contains a moderate amount of flexible aryl ether interunit linkages along with other typical substructure and subunits commonly found in poplar lignin. LCL showing thermal flow behavior is a mixture of oligomers, in which the C—C bonded substructures constitute >50% of the predominate lignin interunit linkages. For MCL-PUs, the mechanical properties were vastly improved by the addition of monomeric diols or polyethers. LCL by itself can form PUs with σₘₐₓ exceeding 50 MPa and T_{g} around 130° C.

CL180 obtained directly via CELF process possessed high frequencies of phenolic -OH functional groups and the most rigid molecular structure among the three CELF lignin samples. The unsaturated aliphatic diol, cBED, exhibited biphasic behavior with CELF lignin, and thus toughened the resulting CL-PUs. Polyether, PEG that can form robust hydrogen bonds with lignin were ineffective in softening the CL-PU network. The strategic combination of cBED and PEG demonstrated enhancement in both toughness and ductility without scarifying the incorporation level of lignin in the CL-PU. Therefore, understanding the molecular interactions within the polymer system and deploying them in designing lignin-based/containing materials could benefit the cost-effective utilization of technical lignin in value-added products.

### Example 2

Representative polyurethanes were prepared using the following method, which illustrates a method of the invention.

Organosolv lignin samples were dissolved in THF with monomeric polyols. The mixture was incubated in a thermal shaker (Alkali Scientific Inc.) at 140 rpm, 60° C. for 1 hour, and then it was combined with a THF solution containing poly[(phenyl isocyanate)-co-formaldehyde] (PMDI, Mₙ˜340) with NCO/OH ratio at 1:1 and 1.5% dibutyltin dilaurate (DTDL). After 3-day curing at room temperature, the CL-PU samples were kept at 150° C. for 3 hours.

All publications, patents, and patent documents (including Yun-Yan Wang, et al., “Polyurethanes Based on Unmodified and Refined Technical Lignins: Correlation between Molecular Structure and Material Properties”, Biomacromolecules 2021 22 (5), 2129-2136) are incorporated by reference herein, as though individually incorporated by reference. The invention has been described with reference to various specific and preferred embodiments and techniques. However, it should be understood that many variations and modifications may be made while remaining within the spirit and scope of the invention.

1. A method comprising, co-polymerizing:
an organosolv lignin;
a monomeric polyol; and
an isocyanate;
to provide a polyurethane.

2-6. (canceled)

7. The method of claim 1, wherein the monomeric polyol is selected from the group consisting of 1,3-propanediol, propylene glycol, 1,4-butanediol, 1,3-butanediol, cis-butene-1,4-diol, trans-butene-1,4-diol, 3-hexene-1,6-diol, and glycerol.

8. The method of claim 1, wherein the monomeric polyol is cis-butene-1,4-diol.

9. (canceled)

10. The method of claim 1, wherein the isocyanate is poly[(phenyl isocyanate)-co-formaldehyde.

11. (canceled)

12. The method of claim 1, wherein the co-polymerizing is carried out in a solvent that comprises a volatile-organic-solvent.

13. (canceled)

14. The method of claim 12, wherein the volatile-organic-solvent comprises tetrahydrofuran.

15. (canceled)

16. The method of claim 1, wherein the co-polymerizing is carried out in the presence of dibutyltin dilaurate catalyst.

17-21. (canceled)

22. The method of claim 1, wherein the polyurethane has an ultimate tensile stress (σₘₐₓ) of at least about 50 MPa.

23. The method of claim 1, wherein the polyurethane has an elongation at break (ε_{b}) of at least about 4%.

24. The method of claim 1, wherein the polyurethane has an elongation at break (ε_{b}) of at least about 8%.

25. The method of claim 1, wherein the polyurethane has a glass transition temperatures (Tg) between about 100° C. and about 180° C.

26. A polyurethane prepared as described in claim 1.

27. A polyurethane comprising lignin that is co-polymerized with a monomeric polyol and an isocyanate.

28. The polyurethane of claim 27, wherein the monomeric polyol is selected from the group consisting of 1,3-propanediol, propylene glycol, 1,4-butanediol, 1,3-butanediol, cis-butene-1,4-diol, trans-butene-1,4-diol, 3-hexene-1,6-diol, and glycerol.

29. The polyurethane of claim 27, wherein the monomeric polyol is cis-butene-1,4-diol.

30-35. (canceled)

36. The polyurethane of claim 27, wherein the polyurethane comprises 10-80% monomeric polyol.

37. The polyurethane of claim 27, wherein the polyurethane has an ultimate tensile stress (σₘₐₓ) of at least about 50 MPa.

38. The polyurethane of claim 27, wherein the polyurethane has an elongation at break (ε_{b}) of at least about 4%.

39. The polyurethane of claim 27, wherein the polyurethane has an elongation at break (ε_{b}) of at least about 8%.

40. The polyurethane of claim 27, wherein the polyurethane has a glass transition temperature (Tg) between about 100° C. and about 180° C.
